(19) United States
(12) Patent Application Publication
(10) Pub. No.: US 2009/0151964 A1
(43) Pub. Date: Jun. 18, 2009

(54) FIGHTING FIRES WITH WATER

(76) Inventor: Alfred Rosen, Palm Beach, FL (US)

Correspondence Address: Stephen G. Rudisill, Esq.;Nixon Peabody LLP, 161 N. Clark Street, 48th Floor, Chicago, IL, 60601, US

(21) Appl. No.: 12/273,633

(22) Filed: Nov. 19, 2008

Related U.S. Application Data
(60) Provisional application No. 61/007,986, filed on Dec. 17, 2007.
(60) Provisional application No. 61/059,419, filed on Jun. 6, 2008.

(51) Int. Cl. A62C 2/00; F25C 3/04; A62C 3/07

(52) U.S. Cl. 169/46; 239/2.2; 169/24

(57) ABSTRACT

A method of suppressing a naturally occurring event that requires heat to sustain itself, comprises the steps of generating artificial snow in the vicinity of the event and introducing the snow into the event to melt therein. One application of this method is extinguishing a fire by generating artificial snow in the vicinity of the fire and introducing the snow into the fire to melt therein. For example a fire boat or truck may carry on a movable structure a snowmaking machine for generating artificial snow and projecting the snow in a desired direction. In another example, a sprinkler system may be modified to spray artificial snow.

### CROSS-REFERENCE TO RELATED APPLICATIONS

This application claims the benefit of U.S. Provisional Patent Application No. 61/007,986, filed Dec. 17, 2007, and U.S. Provisional Patent Application No. 61/059,419 filed Jun. 6, 2008, the contents of which are hereby incorporated by reference herein in their entireties.

### BACKGROUND OF THE INVENTION

For centuries, perhaps millennia, destructive fires have been fought by dousing them with water. This procedure requires huge quantities of water, and the side effects have often been destructive. This invention teaches the use of water in the form of ice particles, snow crystals, or the like to fight destructive fires. The results are expected to be faster extinction of a fire than can be accomplished using liquid water, requiring a relatively lesser quantity of water to do it.

Water extinguishes fire by, among other effects, extracting heat from the fire, at the rate of one calorie per gram per degree Celsius temperature rise of the water. However, the heat of fusion of water is 80 calories per gram. Therefore, using water in an ice form would extract heat from fire at the rate of 80 calories per gram of water merely to melt the ice, before beginning to raise the temperature of the water.

Machines for making artificial snow are in use currently to augment snow surfaces on ski slopes. Sometimes called “snow guns”, a typical type of snow gun produces water droplets by combining cooled water and compressed air. Two different hoses are used to run air and water, respectively, to the snow gun. The compressed air serves three functions—it atomizes the water into many tiny droplets, it blows the water droplets into the surrounding air, and it helps to cool the water droplets as, when released from compression, they spread out and fly into the surrounding air, contributing heat of fusion to the surrounding air and becoming snow in the process. Some snow machines have special cooling units to speed the freezing process when natural conditions are not cold enough to do this job. An example of this type of snow gun is described in U.S. Pat. No. 5,884,841.

Another type of snow machine, called an “airless snow gun”, uses a spray nozzle that atomizes water into a fine mist and a fan to blow the mist into the surrounding air. This type requires only a water supply, hence only one hose. An example of this type of snow gun is described in U.S. Pat. No. 2,968,164.

A fire sprinkler system for extinguishing fires in confined spaces provides water from a network of pipes to overhead nozzles that open automatically with a rise in temperature. This invention improves such systems by converting at least some of the water issuing from the nozzles to ice particles, snow crystals or the like. The results are expected to be faster extinction of a fire than can be accomplished using liquid water, requiring a relatively lesser quantity of water to do it.

It is an object of the invention to improve the art of firefighting by generating ice in a particulate form in the near vicinity of a fire and introducing the generated ice into the fire to melt therein.

Another object of the invention is to improve fire sprinkler systems by adding to them the ability to use water in the form of ice in addition to or in place of liquid water.

This invention teaches to use the technology of snow machines to achieve its stated objects. The invention is not restricted to the use of any particular type of snow machine.

### SUMMARY OF THE INVENTION

In accordance with one embodiment, a method of suppressing a naturally occurring event that requires heat to sustain itself, comprises the steps of generating artificial snow in the vicinity of the event and introducing the snow into the event to melt therein. One application of this method is extinguishing a fire by generating artificial snow in the vicinity of the fire and introducing the snow into the fire to melt therein. For example a fire boat or truck may carry on a movable structure a snowmaking machine for generating artificial snow and projecting the snow in a desired direction.

One implementation is a fire sprinkler system having water confined under pressure supplied to sprinkler nozzles that open and spray water in response to an increase in temperature. At least one air nozzle is associated with each sprinkler nozzle, and a source of compressed air is connected to each air nozzle via a pressure-controlled valve. A line connects the water under pressure to each of the valves holding the valves closed while the system is in a static state with the sprinkler nozzles closed, the valves being responsive to a drop in water pressure to open and supply compressed air to the air nozzles when the sprinkler nozzles are open and spraying water, the air nozzles being oriented to emit streams of compressed air aimed into the spraying water. In one example, a snow gun is adapted for use in a fire sprinkler system wherein the water nozzle includes a thermally responsive member that has the ability to open the nozzle in response to an elevated temperature that signals the presence of fire.

### BRIEF DESCRIPTION OF THE DRAWINGS

The invention will be better understood from the following description of preferred embodiments together with reference to the accompanying drawings, in which:

FIG. 1 is a diagrammatic illustration of a fire boat equipped with an artificial snow making machine;

FIG. 2 is a diagrammatic illustration of a fire truck equipped with an artificial snow making machine; and

FIG. 3 is a diagrammatic illustration of a fire sprinkler system with an artificial snow making machine.

### DETAILED DESCRIPTION OF ILLUSTRATED EMBODIMENT

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

Several examples of practical embodiments of the invention are illustrated in the drawings accompanying this disclosure.

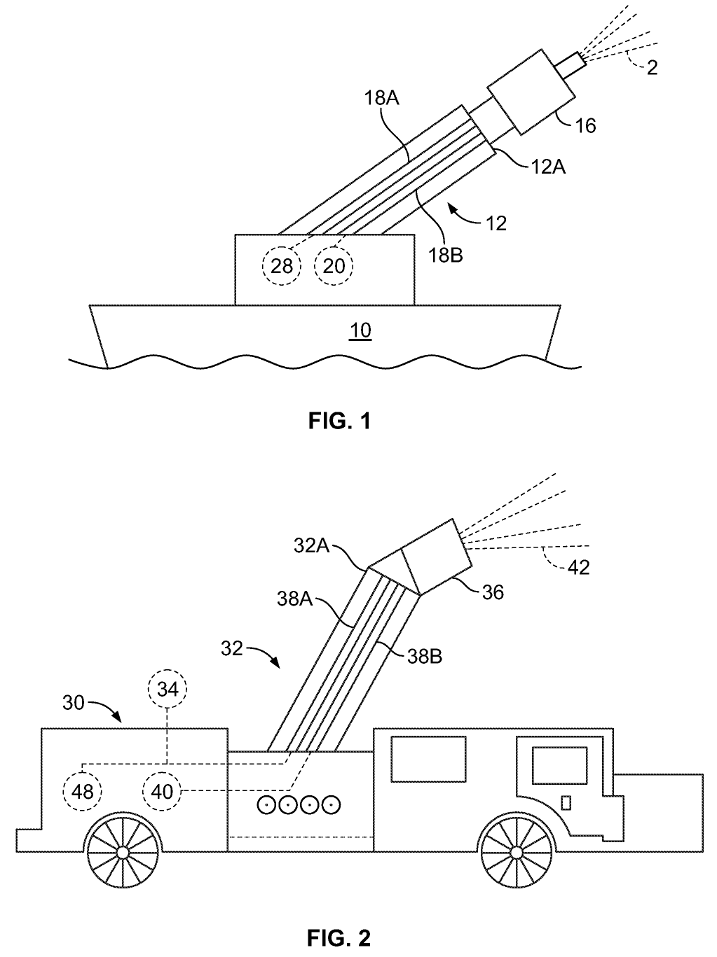

FIG. 1 shows a representation of a fireboat 10 fitted with an extensible boom 12 normally carrying a hose nozzle (not shown) at its remote end 12A. A snow machine 16 is fixed to the boom at the remote end 12A. Water and air hoses 18A and 18B for supplying water and air, respectively, to the snow machine, are carried by the boom in addition to the usual fire hose (not shown). Water for the snow machine may be supplied from the existing water pumping facilities of the fireboat, or separately, as desired. A pump 20 to supply compressed air to the snow machine may be added, if needed. A refrigerator unit 28 may be fitted in the water hose 18A, if needed. With these additions the fireboat is modified to include the ability to fight fires with artificial snow 22 from the snow machine with or without water from its hose nozzle.

FIG. 2 shows a representation of a fire truck 30 fitted with an extensible boom 32 normally carrying a hose nozzle (not shown) at its remote end 32A. A snow machine 36 is fixed to the boom at the remote end 32A. Water and air hoses 38A and 38B for supplying water and air, respectively, to the snow machine, are carried by the boom in addition to the usual fire hose (not shown). Water for the snow machine may be supplied from the existing water pumping facilities of the fire truck, or by separate facilities, as desired. A pump 40 to supply compressed air to the snow machine may be added, if needed. A refrigerator unit 48 may be fitted to the water hose 38A, via a conduit 34, if needed. With these additions the fire truck is modified to include the ability to fight fires with artificial snow 42 from the snow machine, with or without water from its existing hose nozzle.

Snow machines are used to make snow. Users want the snow to endure, as on ski slopes. Early melting is not desired. In this invention, to the contrary, it is intended that the snow will melt, in a fire. The artificial snow is made in a process that gives heat to the ambient environment and is melted in a fire to take heat from the fire.

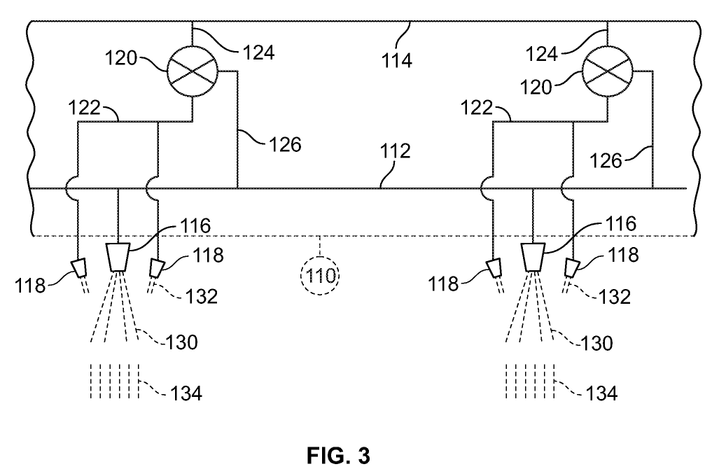

FIG. 3 illustrates another example of a practical embodiment of the invention. A water feed line 112 supplies water to sprinkler nozzles 116, of which two are shown. These are components of an existing fire sprinkler system using nozzles of a design approved for that use. As such, each nozzle includes a temperature sensitive member (not shown) that opens the nozzle when the ambient temperature reaches a pre-set level, releasing a spray of water 130. Typically, the temperature sensitive member includes a fusible element. The dashed line 110 indicates the ceiling, above which the entire system, except the water sprinkler nozzles, may be concealed in a particular installation.

The invention adds an air feed line 114, air nozzles 118, and pressure-controlled valves 120 to the system. Compressed air from the air line 114 is fed to the valves 120 via lines 124, and through the valves when open to the air nozzles 118 via lines 122. While the system is in a static state, in the absence of fire and the sprinkler nozzles 116 are closed, water pressure from the water feed line 112 via lines 126 holds the valves 120 closed. In the event of fire the sprinkler nozzles 116 open and the water pressure seen by the valves 120 drops allowing the valves 120 to open and supply compressed air to the air nozzles 118, which then emit streams of compressed air 132 aimed into the sprays of water 130. These are the conditions for forming artificial snow 134 from some or all of the sprays of water 130.

As used herein, the term “artificial snow” includes any solid form of water regardless of whether it is an ice crystal or an ice particle, and regardless of whether it is in the form of single crystals or particles or an agglomeration of multiple crystals or particles.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A method of suppressing a naturally occurring event that requires heat to sustain itself, comprising the steps of generating artificial snow in the vicinity of said event and introducing said snow into said event to melt therein.

2. A method according to claim 1 comprising the steps of generating said artificial snow in the vicinity of a fire and introducing said snow into said fire to melt therein.

3. A vehicle bearing on a movable structure a snowmaking machine for generating artificial snow and projecting said snow in a desired direction relative to said vehicle.

4. A vehicle according to claim 3 wherein said vehicle is selected from the group consisting of a fire truck and a fireboat.

5. In a fire sprinkler system having water confined under pressure supplied to sprinkler nozzles that open and spray water in response to an increase in temperature, at least one air nozzle associated with each sprinkler nozzle, a source of compressed air and a connection from said source to each air nozzle via a pressure-controlled valve, and a line connecting said water under pressure to each of said valves holding said valves closed while said system is in a static state with said sprinkler nozzles closed, said valves being responsive to a drop in water pressure to open and supply compressed air to said air nozzles when said sprinkler nozzles are open and spraying water, said air nozzles being oriented to emit streams of compressed air aimed into said spraying water.

6. A snow gun adapted for use in a fire sprinkler system wherein the water nozzle includes a thermally responsive member that has the ability to open the nozzle in response to an elevated temperature that signals the presence of fire.

7. A snow gun according to claim 6 wherein said thermally responsive member includes a fusible element holding the nozzle closed.
